(19) United States
(12) Patent Application Publication
(10) Pub. No.: US 2010/0009693 A1
(43) Pub. Date: Jan. 14, 2010

(54) Base Station, Scheduling Method, And Wireless Terminal

(76) Inventors: Kazuo KAWABATA, Kawasaki (JP); Ryusuke Kiryu, Kawasaki (JP)

Correspondence Address: HANIFY & KING PROFESSIONAL CORPORATION, 1055 Thomas Jefferson Street, NW, Suite 400, WASHINGTON, DC, 20007, US

(21) Appl. No.: 12/561,036

(22) Filed: Sep. 16, 2009

Related U.S. Application Data
(63) Continuation of application No. PCT/JP2007/056326, filed on Mar. 27, 2007.

(51) Int. Cl. H04W 72/00

(52) U.S. Cl. 455/450; 455/509

(57) ABSTRACT

In a base station, a received signal strength calculation unit calculates the received signal strength of data sent by wireless terminals. A scheduler re-allocates the wireless resource next to a wireless terminal that will cause the smallest change from the received signal strength of the currently allocated wireless terminal. The base station can receive data sent from the wireless terminals in such a manner that the received signal strength varies gradually, and degradation in quality of reception can be suppressed.

This application is a continuing application, filed under 35 U.S.C. Section 111(a) of International Application PCT/JP2007/056326, filed Mar. 27, 2007.

### FIELD

The embodiments discussed herein are related to base stations, scheduling methods, and wireless terminals.

### BACKGROUND

It is known that the level of received radio waves may significantly change because of distance attenuation and fading of radio waves in wireless communication systems such as mobile phones. A base station has an analog-to-digital (A-D) converter for converting the received signal from analog to digital, for digital processing of the received signal. Generally, the A-D converter has a not so wide dynamic range. In order to expand the dynamic range of the A-D converter, the base station generally has an automatic gain control (AGC).

FIG. 12 is a block diagram of the base station. As illustrated in FIG. 12, the base station has an AGC 101, an A-D converter 102, and a baseband (BB) processing unit 103. The AGC 101 performs gain control to make the magnitude of received signals at an antenna fall within a specified range. The A-D converter 102 performs analog-to-digital conversion of the signal output from the AGC 101. The BB processing unit 103 performs baseband signal processing of the digital signal output from the A-D converter.

As has been described above, the received signal strength may not be constant in the wireless communication system. The AGC 101 performs gain control of the received signal, so that the signal input to the A-D converter 102 is kept in the specified range. This allows the dynamic range of the A-D converter 102 to be expanded.

The received signal strength at continuous communication such as a voice call varies relatively gradually. In the case of packet transmissions with the code division multiple access (CDMA) scheme, the users send data simultaneously. Even if a user sends data at a burst, the received signal strength changes relatively gradually because signals from a plurality of users are received together. Accordingly, the AGC 101 performs gain control with a relatively large time constant.

FIG. 13 is a view illustrating variations in received signal strength. The variations in received signal strength at continuous communication such as a voice call are illustrated in FIG. 13. The received signal strength in continuous communication varies gradually as illustrated in FIG. 13. Therefore, the AGC 101 can perform gain control with a relatively large time constant.

FIG. 14 is a view illustrating timing of data transmission by users. The data transmission timing of CDMA users U1 to U100 is illustrated in FIG. 14. Because the CDMA users U1 to U100 send data simultaneously, burst data transmission by a user (the user U2 in FIG. 14) will not significantly change the received signal strength owing to the statistical multiplex effect. Therefore, the AGC 101 can perform gain control with a relatively large time constant.

There has been provided a wireless communication apparatus that can implement optimum gain control by the AGC circuits in a short time from the beginning of reception, by setting a plurality of antennas to have different reception levels through varying the gain values of the AGC circuits corresponding to the antennas in the standby state (refer to Japanese Laid-open Patent Publication No. 2005-278017, for instance).

In next-generation wireless communication systems such as long term evolution (LTE), a plurality of users are supposed to use a single wireless resource (common resource) in a time division manner. Received signal strength of signals received at the base station significantly varies from slot to slot. The conventional AGC with a large time constant is unable to follow such variations in the received signal strength, resulting in degraded quality of reception.

FIG. 15 is a view illustrating an example positional relationship among a base station and wireless terminals. Suppose that the wireless terminals 111 to 114 are placed with respect to the base station 121, as illustrated in FIG. 15. Numbers in parentheses in FIG. 15 indicate places in short-distance ranking between the base station 121 and the wireless terminals 111 to 114. In the example illustrated in FIG. 15, the distance between the wireless terminal 111 and the base station 121 is the shortest, and the distance between the wireless terminal 114 and the base station 121 is the longest.

FIG. 16 is a view illustrating variations in received signal strength in the next-generation wireless communication system. The received signal strength from the wireless terminals 111 to 114 illustrated in FIG. 15 is shown in FIG. 16. The received signal strength 131 indicates the received signal strength from the wireless terminal 111. The received signal strength 132 indicates the received signal strength from the wireless terminal 112. The received signal strength 133 indicates the received signal strength from the wireless terminal 113. The received signal strength 134 indicates the received signal strength from the wireless terminal 114. The magnitude of the received signal strength 131 to 134 is proportional to the distance between the base station 121 and the wireless terminals 111 to 114 illustrated in FIG. 15.

Numbers in boxes in FIG. 16 indicate the reference numerals 111 to 114 of the wireless terminals illustrated in FIG. 15, showing the correspondence between the received signal strength 131 to 134 and the wireless terminals 111 to 114.

For example, the base station allocates a frequency band to the wireless terminals 111 to 114 in a time division manner, by using a scheduler. The wireless terminals 111 to 114 send data by using the frequency band allocated by the scheduler of the base station. In the example illustrated in FIG. 16, the wireless terminals 111 to 114 send data in the order indicated by the reference numerals in the boxes.

In the next-generation wireless communication systems such as the LTE, the plurality of wireless terminals 111 to 114 use a single wireless resource (such as a frequency band) in a time division manner. The number of users in a unit time is small (1 in the example illustrated in FIG. 16). Therefore, the received signal strength of signals received at the base station significantly varies from slot to slot, as illustrated in FIG. 16.

FIG. 17 illustrates the quality of reception degraded by a poor follow-up of the AGC. The received signal strength 141 to 143 in each slot is illustrated in FIG. 17. A follow-up change 151 of AGC gain control is also illustrated.

As illustrated in FIG. 17, the AGC gain changes with slot-to-slot variations in received signal strength 141 to 143. As the change in AGC gain has a time constant, the slot-to-slot variations in received signal strength 141 to 143 may not be followed, as indicated by the follow-up change 151 in FIG. 17.

In an area 161 (area shaded with diagonal lines from top left to bottom right) in FIG. 17, because the input level of the A-D converter becomes insufficient, the quality of reception is degraded. In an area 162 (area shaded with diagonal lines from top right to bottom left) in FIG. 17, because the input level of the A-D converter is excessive, the quality of reception is degraded.

As described with reference to FIG. 16, in the next-generation wireless communication systems such as the LTE, the received signal strength significantly varies from slot to slot, so that the quality of reception at the base station is greatly degraded.

### SUMMARY

In an aspect of the embodiments, a base station that performs scheduling of wireless terminals has a received signal strength calculation unit for calculating the received signal strength of data sent by the wireless terminals and a scheduler for allocating communication to a wireless terminal that will cause the smallest change from the received signal strength of a currently allocated wireless terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIGS. 1A and 1B are views illustrating the outline of a base station;

FIG. 2 is a view illustrating a wireless communication system using a base station according to a first embodiment;

FIG. 3 is a block diagram illustrating the base station;

FIG. 4 is a view illustrating an example data structure of a received signal strength table;

FIG. 5 is a view illustrating variations in received signal strength when scheduling is performed to minimize the variations in received signal strength;

FIG. 6 is a sequence diagram of the base station and wireless terminals;

FIG. 7 is a flowchart illustrating the operation of a scheduler;

FIG. 8 is a view illustrating time constraints in wireless resource allocation;

FIG. 9 is a flowchart illustrating the operation of a scheduler according to a second embodiment;

FIG. 10 is a flowchart illustrating the operation of a scheduler according to a third embodiment;

FIG. 11 is a flowchart illustrating the operation of a scheduler according to a fourth embodiment;

FIG. 12 is a block diagram of a base station;

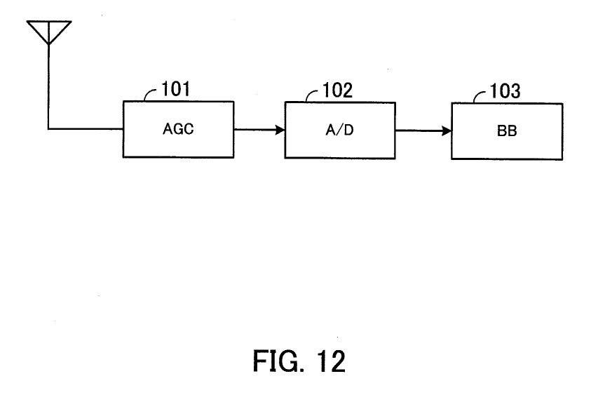

FIG. 13 is a view illustrating variations in received signal strength;

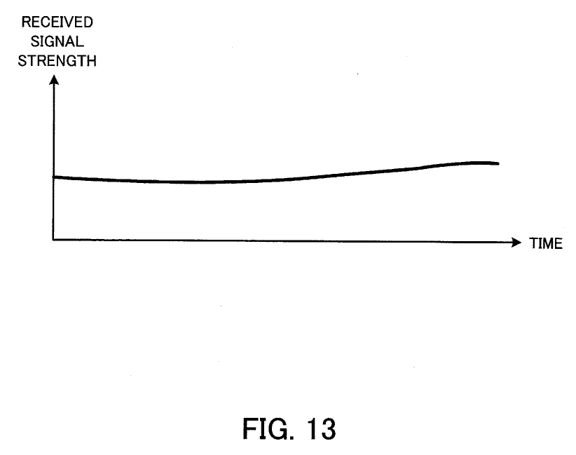

FIG. 14 is a view illustrating timing of data transmission by users;

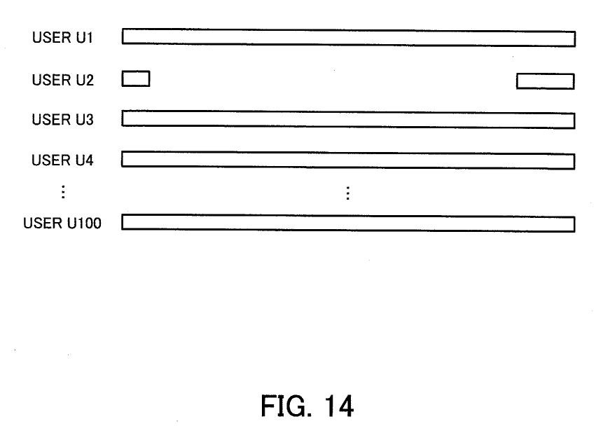

FIG. 15 is a view illustrating an example of positional relationship among a base station and wireless terminals;

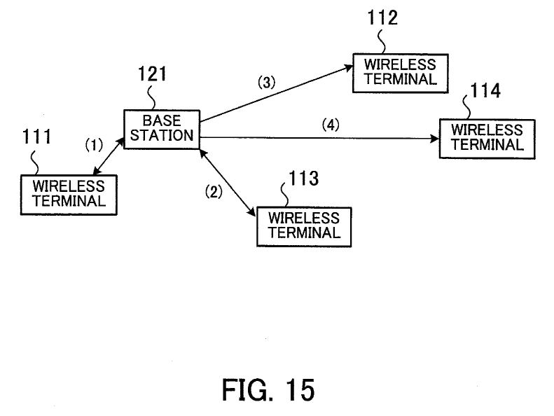

FIG. 16 is a view illustrating variations in received signal strength in a next-generation wireless communication system; and

FIG. 17 is a view illustrating the quality of reception degraded by a poor follow-up of an AGC.

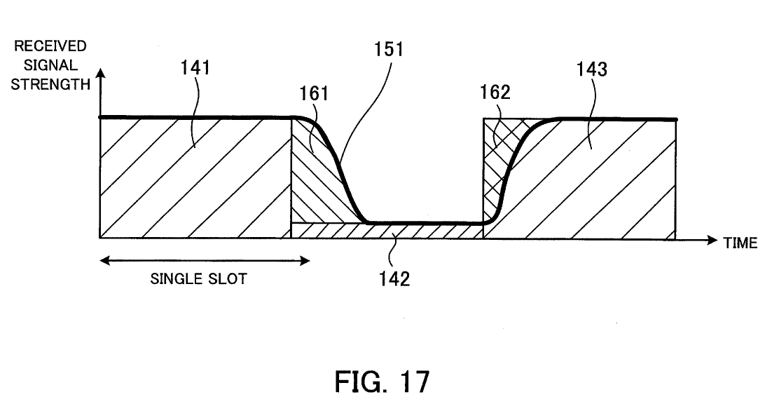

### DESCRIPTION OF EMBODIMENT(S)

Embodiments of the present invention will be described in detail with reference to the drawings.

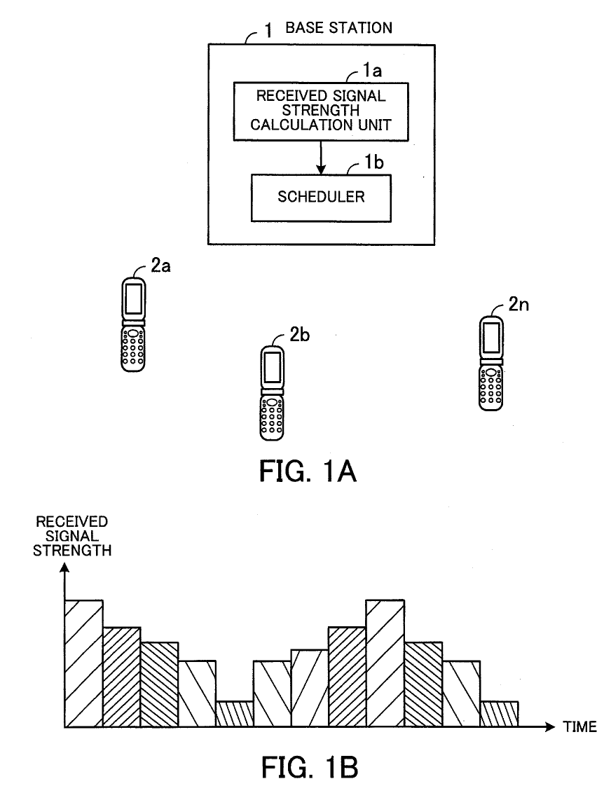

FIGS. 1A and 1B are views illustrating the outline of a base station. Together with the outline of a base station 1, wireless terminals 2a to 2n which perform wireless communication with the base station 1 are illustrated in FIG. 1A. FIG. 1B illustrates the received signal strength at the base station 1, of data sent by the wireless terminals 2a to 2n.

The base station 1 has a received signal strength calculation unit 1a and a scheduler 1b.

The received signal strength calculation unit 1a calculates the received signal strength of data sent by the wireless terminals 2a to 2n.

The scheduler 1b re-allocates a wireless resource next to any of the wireless terminals 2a to 2n that will cause the smallest change from the received signal strength of the currently allocated one of the wireless terminals 2a to 2n.

Let the wireless resource be currently allocated to the wireless terminal 2a and the wireless terminal that will cause the smallest change from the received signal strength of the wireless terminal 2a be the wireless terminal 2b. Then, the scheduler 1b re-allocates the wireless resource next to the wireless terminal 2b. After that, the scheduler 1b re-allocates again the wireless resource from the wireless terminal 2b to another wireless terminal that will cause the smallest change from that received signal strength.

The scheduler 1b continues to re-allocate the wireless resource to the wireless terminals 2a to 2n one after another in such a manner that the smallest change will be made in received signal strength. Accordingly, the base station 1 receives data sent from the wireless terminals 2a to 2n with the received signal strength varying as illustrated in FIG. 1B. The received signal strength at the base station 1 varies gradually as illustrated in FIG. 1B.

This allows the AGC of the base station 1 to follow variations in received signal strength more accurately, and degradation in quality of reception can be suppressed.

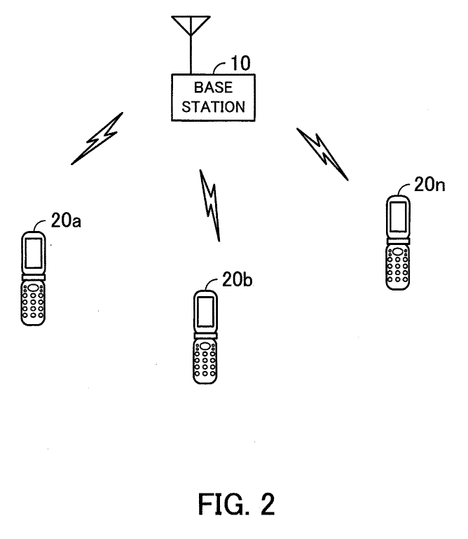

A first embodiment will be described next in detail with reference to FIGS. 2 to 7.

FIG. 2 is a view illustrating a wireless communication system using a base station of the first embodiment. The view contains a base station 10 and wireless terminals 20a to 20n, which are mobile phones, for instance. The base station 10 and the wireless terminals 20a to 20n perform wireless communication based on the LTE wireless communication system, for example.

The base station 10 allocates a wireless resource (common resource) such as a frequency band to the wireless terminals 20a to 20n in a time division manner. The wireless terminals 20a to 20n perform wireless communication with the base station 10 in a time division manner, by using the frequency band allocated as scheduled by the base station 10.

The base station 10 calculates the signal strength (received signal strength) of data signals sent by the wireless terminals 20a to 20n. The base station 10 performs scheduling of the wireless terminals 20a to 20n on the basis of the calculated received signal strength. For instance, the scheduling of the wireless terminals 20a to 20n is performed to provide gradual variations in received signal strength. More specifically, the frequency band is re-allocated from a wireless terminal to another in such a manner that the change in received signal strength will be the smallest.

Through such scheduling of the wireless terminals 20a to 20n that the received signal strength varies gradually, the AGC can follow the variations in received signal strength more accurately, and the degradation in quality of reception can be suppressed.

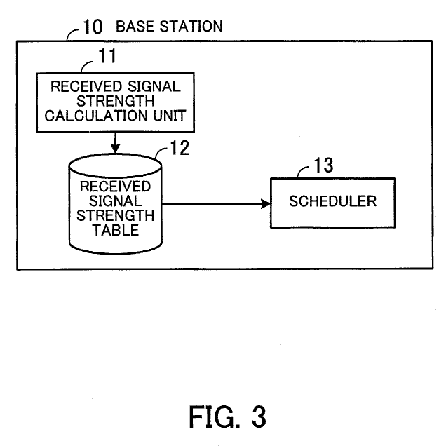

FIG. 3 is a block diagram of the base station. As illustrated in FIG. 3, the base station 10 includes a received signal strength calculation unit 11, a received signal strength table 12, and a scheduler 13.

The received signal strength calculation unit 11 calculates the received signal strength of the wireless terminals 20a to 20n. The received signal strength can be calculated in different methods, such as (1) to (4) described below.

(1) The strength of reception of a request signal is regarded as being the received signal strength. Request signals are sent from the wireless terminals 20a to 20n to the base station when they request data transmission. The received signal strength calculation unit 11 calculates the strength of reception of the request signals sent from the wireless terminals 20a to 20n as the received signal strength of data sent by the wireless terminals 20a to 20n.

(2) The sum of the received signal strength calculated in (1) above and an offset value is regarded as being the received signal strength. In some wireless communication systems, the wireless terminals 20a to 20n increase their transmission power when they send data. In a wireless communication system with a high transmission rate, for example, the wireless terminals 20a to 20n send data with transmission power higher than that for the request signal. If the wireless communication system has a specified offset value (increase in transmission power of wireless terminals), the received signal strength calculation unit 11 calculates the received signal strength by adding the offset value to the received signal strength calculated from the request signal.

In some cases, the base station 10 gives the wireless terminals 20a to 20n an offset value of data transmission, in scheduling. In such cases, the received signal strength calculation unit 11 calculates the received signal strength by adding the offset value given to the wireless terminals 20a to 20n to the received signal strength calculated from the request signals.

(3) The distances between the base station 10 and the wireless terminals 20a to 20n are measured, and the received signal strength is calculated by subtracting the amounts of distance attenuation from the data transmission power of the wireless terminals 20a to 20n. The data transmission power of the wireless terminals 20a to 20n is fixed, and the base station 10 recognizes the data transmission power beforehand.

(4) The sum of the received signal strength calculated in (3) above and an offset value is regarded as being the received signal strength. In some wireless communication systems, the wireless terminals 20a to 20n send data with increased transmission power, as in (2) above. The received signal strength is obtained by adding the offset value to the received signal strength calculated in (3) above.

In some cases, the base station 10 gives the wireless terminals 20a to 20n an offset value of data transmission, in scheduling. In such cases, the received signal strength calculation unit 11 calculates the received signal strength by adding the offset value given to the wireless terminals 20a to 20n to the received signal strength calculated in (3) above.

The distances between the base station 10 and the wireless terminals 20a to 20n can be measured in different methods, such as (11) to (13) described below:

(11) The propagation delays of signals between the base station 10 and the wireless terminals 20a to 20n are measured. For example, the base station 10 outputs a specified signal to the wireless terminals 20a to 20n, and the distances between the base station 10 and the wireless terminals 20a to 20n are measured on the basis of time periods until the reception of the response signals.

(12) The wireless terminals 20a to 20n report their transmission power values to the base station 10. The base station calculates the distance from the difference between the received power value of an actually received signal and the reported transmission power value.

(13) The position of each terminal is obtained by using a function to provide positional information, such as the global positioning system (GPS). For example, the wireless terminals 20a to 20n have the GPS function and report their current positions to the base station 10. From the current positions reported from the wireless terminals 20a to 20n, the base station 10 calculates the distances to the wireless terminals 20a to 20n.

The received signal strength calculation unit 11 stores the received signal strength of the wireless terminals 20a to 20n calculated by any of the methods (1) to (4) described above, in the received signal strength table 12.

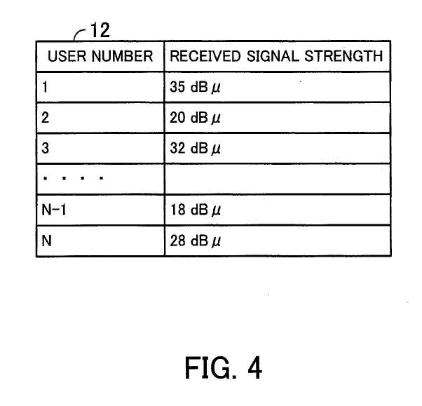

FIG. 4 is a view illustrating an example data structure of the received signal strength table 12. As illustrated in FIG. 4, the received signal strength table 12 has a user number column and a received signal strength column. In the user number column, numbers identifying the wireless terminals 20a to 20n are stored. In the received signal strength column, the received signal strength of the wireless terminals 20a to 20n is stored. The received signal strength table 12 is implemented by a memory such as a random access memory (RAM).

The description of FIG. 3 will continue. The scheduler 13 performs scheduling of the wireless terminals 20a to 20n in accordance with the received signal strength in the received signal strength table 12. The scheduler 13 next re-allocates the wireless resource from the currently allocated one to another among the wireless terminals 20a to 20n in such a manner that the change in received signal strength will be the smallest.

Suppose that the wireless resource is allocated to the wireless terminal having user number ‘1’ in FIG. 4, for example. The scheduler 13 will next allocate the resource to the wireless terminal having user number ‘3’ because it causes the smallest change in received signal strength.

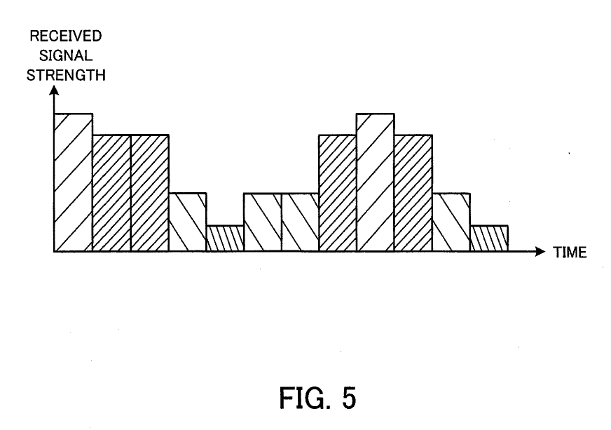

FIG. 5 is a view illustrating variations in received signal strength when scheduling is performed to minimize variations in received signal strength. The received signal strength of the wireless terminals 20a to 20n is illustrated in FIG. 5.

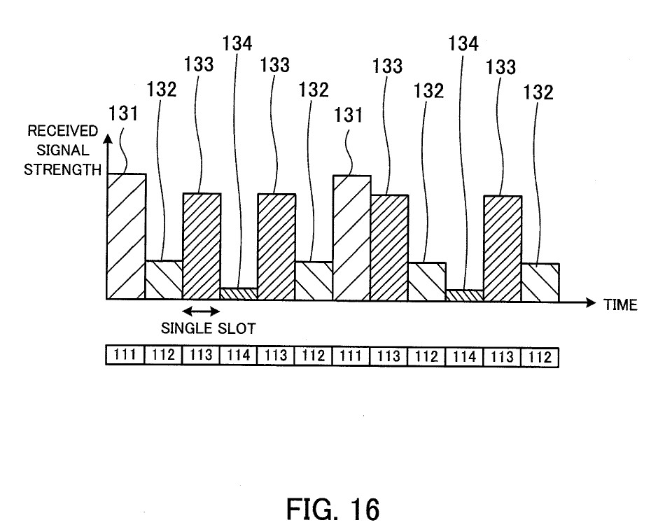

The scheduler 13 allocates the wireless resource to the wireless terminals 20a to 20n in such a manner as to minimize changes in received signal strength. For example, the scheduler 13 allocates the wireless resource to the wireless terminals 20a to 20n in such a manner that the received signal strength decreases. After the wireless resource is allocated to the wireless terminal that provides the smallest received signal strength, the wireless resource is then re-allocated to the wireless terminals 20a to 20n in such a manner that the received signal strength increases. Accordingly, the received signal strength varies more gradually in FIG. 5 than in FIG. 16.

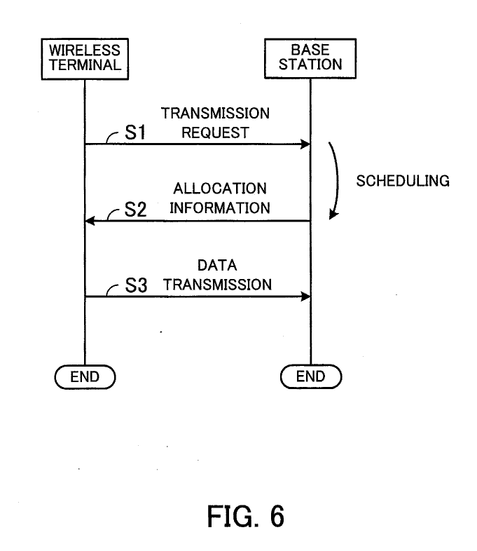

FIG. 6 is a sequence diagram of the base station and the wireless terminals. The base station 10 and the wireless terminals 20a to 20n exchange data, following the steps described below.

In step S1, the wireless terminals 20a to 20n send transmission requests to the base station 10 as data transmission requests.

In step S2, the base station 10 receives the transmission requests from the wireless terminals 20a to 20n and performs scheduling of the wireless terminals 20a to 20n. The base station 10 sends allocation information (result of scheduling) to the wireless terminals 20a to 20n.

In step S3, the wireless terminals 20a to 20n send data to the base station 10 in accordance with the result of scheduling by the base station 10.

When the received signal strength calculation unit 11 calculates the received signal strength in the method (1) or (2) described earlier, the received signal strength is calculated in accordance with the request signal sent in step S1. The calculated received signal strength is stored in the received signal strength table 12.

When the received signal strength calculation unit 11 calculates the received signal strength in the method (3) or (4) described earlier, the distances between the base station 10 and the wireless terminals 20a to 20n are measured in accordance with any of the methods (11) to (13) described earlier, then the received signal strength is calculated. The calculated received signal strength is stored in the received signal strength table 12.

The scheduler 13 of the base station 10 performs scheduling of the wireless terminals 20a to 20n on the basis of the received signal strength stored in the received signal strength table 12. The scheduling in step S2 will be described below in detail.

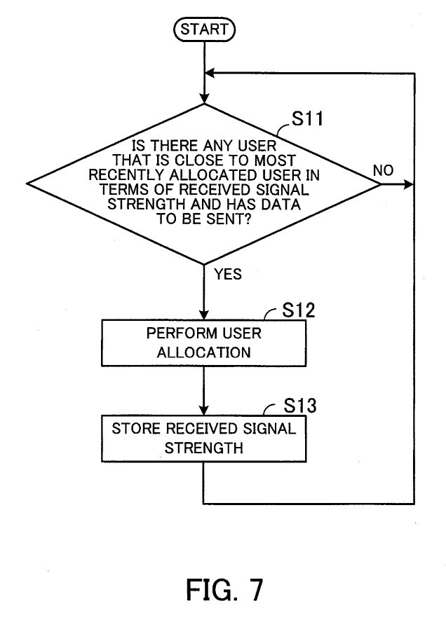

FIG. 7 is a flowchart illustrating the operation of the scheduler 13. The scheduler 13 of the base station 10 performs scheduling of the wireless terminals 20a to 20n, following the steps described below.

In step S11, the scheduler 13 of the base station 10 determines whether any user (wireless terminal) is close, in terms of received signal strength, to the user to which the wireless resource has been allocated most recently, and also has data to be sent, with reference to the received signal strength table 12.

If a user is close to the most recently allocated user in terms of received signal strength and has data to be sent, the scheduler 13 goes to step S12. If there is no such user, the process of step S11 is repeated.

In step S12, the scheduler 13 allocates the wireless resource to the user that is close to the immediately preceding user in terms of received signal strength and has data to be sent.

In step S13, the scheduler 13 stores the received signal strength of the user to which the wireless resource has been allocated, in a memory such as a RAM, for instance. Then, when the scheduler 13 executes the process of step S11 again, the received signal strength stored in the RAM is used to determine whether there is the next user that causes the smallest change in received signal strength.

The base station 10 re-allocates the wireless resource from the currently allocated wireless terminal to such a wireless terminal among the wireless terminals 20a to 20n that the change in received signal strength becomes the smallest.

Accordingly, the base station 10 receives data sent from the wireless terminals 20a to 20n in such a manner that the received signal strength varies gradually. The AGC can follow variations in received signal strength more accurately, so that degradation in quality of reception can be suppressed.

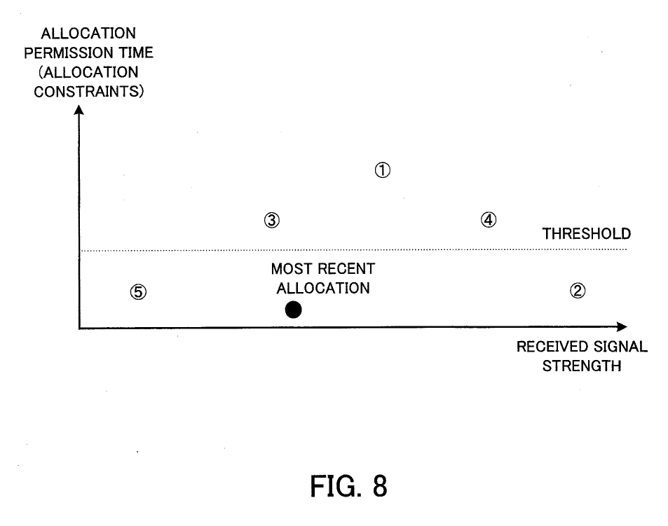

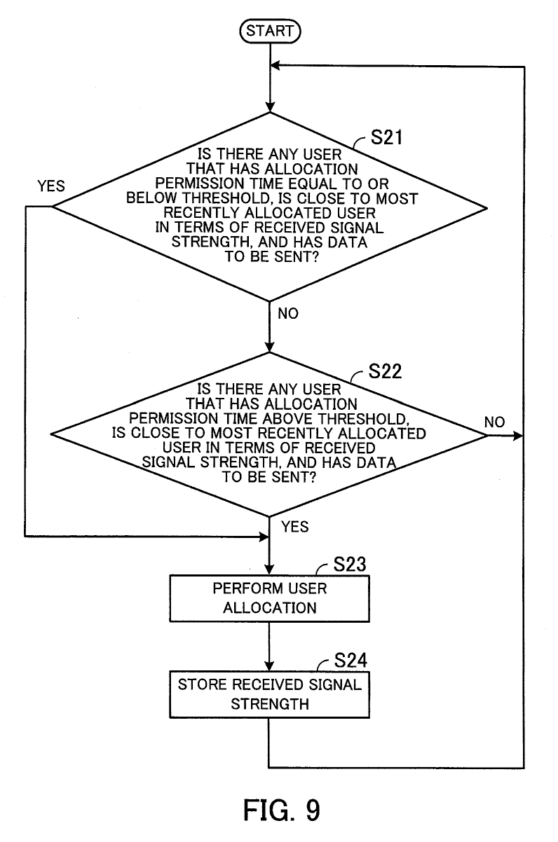

A second embodiment will be described in detail with reference to FIGS. 8 and 9. The scheduler 13 in the first embodiment re-allocates the wireless resource to a user that will cause the smallest change in received signal strength. However, there could be a user which requires the wireless resource first with respect to the quality of service (QoS). In the second embodiment, the wireless resource is allocated preferentially to a user under time constraints.

The scheduler of a base station in the second embodiment has the same function as the scheduler 13, and allocates the wireless resource preferentially to a wireless terminal that has severe time constraints in wireless resource allocation. For example, the scheduler has a threshold of allocation permission time. The scheduler re-allocates the wireless resource to the wireless terminal that causes the smallest change in received signal strength among wireless terminals having the allocation permission time shorter than the threshold.

FIG. 8 is a view illustrating time constraints in wireless resource allocation. In FIG. 8, the horizontal axis indicates the received signal strength, and the vertical axis indicates the allocation permission time. Numbers in FIG. 8 represent the user numbers of the wireless terminals. A black circle represents the wireless terminal to which the wireless terminal is allocated at present.

An upper position on the vertical axis represents a lower QoS, and a lower position represents a higher QoS. A wireless terminal in a lower part of the graph has severe time constraints and requires preferential allocation of the wireless resource. In the example illustrated in FIG. 8, the wireless resource needs to be allocated preferentially to the wireless terminals of user numbers ‘2’ and ‘5’ under severe time constraints. The wireless terminal of user number ‘1’ has relaxed time constraints and does not require preferential allocation of the wireless resource.

In the example illustrated in FIG. 8, the wireless terminals of user numbers ‘2’ and ‘5’ have a permission time lower than the threshold. The scheduler performs scheduling of the wireless terminals of user numbers ‘2’ and ‘5’. The wireless terminal of user number ‘5’ causes the smallest change from the received signal strength of the wireless terminal (represented by the black circle) to which the wireless resource has been allocated most recently. Accordingly, the scheduler re-allocates the wireless resource to the wireless terminal of user number ‘5’. Then, the wireless resource is re-allocated to the wireless terminal of user number ‘2’.

FIG. 9 is a flowchart illustrating the operation of the scheduler in the second embodiment. The scheduler of the base station performs scheduling for the wireless terminals, following the steps described below.

In step S21, the scheduler determines whether any user having an allocation permission time equal to or below the threshold of allocation permission time is close to the most recently allocated user in terms of received signal strength and has data to be sent. If there is a user that has an allocation permission time equal to or below the threshold, is close to the most recently allocated user in terms of received signal strength, and has data to be sent, the scheduler goes to step S23. If there is no such user, the scheduler goes to step S22.

In step S22, the scheduler determines whether a user having an allocation permission time above the threshold of allocation permission time is close to the most recently allocated user in terms of received signal strength and has data to be sent. If there is a user that has an allocation permission time above the threshold, is close to the most recently allocated user in terms of received signal strength, and has data to be sent, the scheduler goes to step S23. If there is no such user, the scheduler goes to step S21.

In step S23, the scheduler allocates the wireless resource to the user that is close to the most recently allocated user in terms of received signal strength and has data to be sent.

In step S24, the scheduler stores the received signal strength of the user to which the wireless resource has been allocated, in a memory such as a RAM, for instance. Then, when the scheduler executes the process of step S21 again, the received signal strength stored in the RAM is used to determine whether there is a user that causes the smallest change in received signal strength.

The base station re-allocates the wireless resource to users in order of severity of allocation permission time. This makes it possible to vary the received signal strength gradually and to allocate the users in descending order of quality such as QoS.

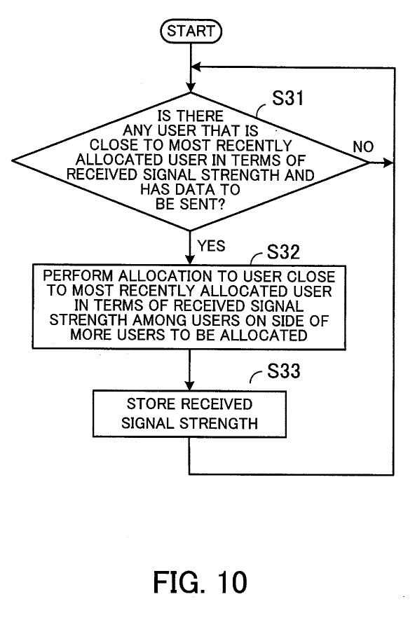

A third embodiment will be described next in detail with reference to FIG. 10. In the third embodiment, a base station re-allocates the wireless resource to users on a side where there are more users that need to be allocated, viewed from the currently allocated user, in ascending order of change in received signal strength.

In the example illustrated in FIG. 8, in comparison with the user allocated most recently (black circle), users having a higher received signal strength (user numbers ‘1’, ‘2’, ‘4’) outnumber users having a lower received signal strength (user numbers ‘3’, ‘5’). The re-allocation proceeds to the side on which there are more users to be scheduled (in a direction in which the received signal strength increases in FIG. 8), and the user of user number ‘1’ is allocated next. In this description, the allocation permission time is ignored (supposing that all the users have the same time constraints).

FIG. 10 is a flowchart illustrating the operation of a scheduler in the third embodiment. The scheduler of the base station performs scheduling of the wireless terminals, following the steps described below.

In step S31, the scheduler references the received signal strength to determine whether there is a user that is close to the most recently allocated user in terms of received signal strength and has data to be sent.

If there is a user that is close to the most recently allocated user in terms of received signal strength and has data to be sent, the scheduler goes to step S32. If there is no such user, the scheduler repeats the process of step S31.

In step S32, the scheduler allocates the wireless resource to a user that is close to the most recently allocated user in terms of received signal strength, on the side where there are more users requiring wireless resource allocation.

In step S33, the scheduler stores the received signal strength of the user to which the wireless resource has been allocated, in a memory such as a RAM, for instance. When the scheduler executes the process of step S31 again, the received signal strength stored in the RAM is used to determine whether there is a next user that will cause the smallest change in received signal strength.

In the process described above, the transmission data is successively transmitted and the wireless resource used in that transmission is released. Finally, every user will have gained an allocation of the wireless resource. The user to which the wireless resource is allocated last among the users in the received signal strength table has either the largest received signal strength or the smallest received signal strength among the allocated users. When the scheduler next performs scheduling of users in a new received signal strength table, the received signal strength of the user allocated last is used as the start point, and the wireless resource is reallocated to the user that will cause the smallest change in received signal strength on the side of more users.

By allocating the wireless resource to users on the side of more users, the probability of providing gradual variations in received signal strength can be raised. This allows the AGC to follow received signal strength more accurately, and the degradation in quality of reception can be suppressed.

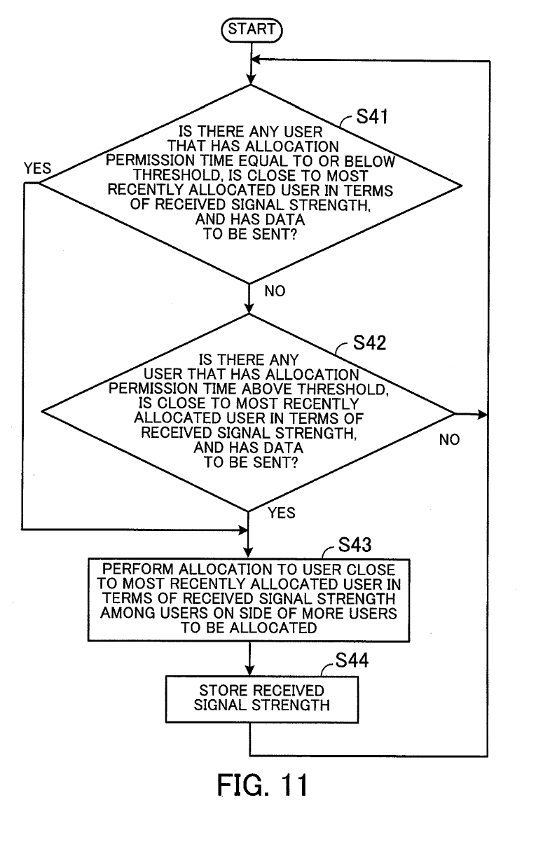

A fourth embodiment will be described in detail with reference to FIG. 11. In the fourth embodiment, the users have time constraints in allocation, and the wireless resource is allocated to users on the side having more users to be allocated, viewed from the currently allocated user, in ascending order of change in received signal strength. The fourth embodiment combines the scheduling of the base station described in the third embodiment and the condition of allocation permission time described in the second embodiment.

FIG. 11 is a flowchart illustrating the operation of a scheduler in the fourth embodiment. The scheduler of the base station performs scheduling of the wireless terminals, following the steps described below.

In step S41, the scheduler determines whether any user having an allocation permission time equal to or below the threshold of allocation permission time is close to the most recently allocated user in terms of received signal strength and has data to be sent. If there is a user that has an allocation permission time equal to or below the threshold, is close to the most recently allocated user in terms of received signal strength, and has data to be sent, the scheduler goes to step S43. If there is no such user, the scheduler goes to step S42.

In step S42, the scheduler determines whether a user having an allocation permission time above the threshold of allocation permission time is close to the most recently allocated user in terms of received signal strength and has data to be sent. If there is a user that has an allocation permission time above the threshold of allocation permission time, is close to the most recently allocated user in terms of received signal strength, and has data to be sent, the scheduler goes to step S43. If there is no such user, the scheduler goes to step S41.

In step S43, the scheduler allocates the wireless resource to a user that is close to the most recently allocated user in terms of received signal strength, on the side where there are more users requiring wireless resource allocation.

In step S44, the scheduler stores the received signal strength of the user to which the wireless resource has been allocated, in a memory such as a RAM, for instance. Then, when the scheduler executes the process of step S41 again, the received signal strength stored in the RAM is used to determine whether there is the next user that causes the smallest change in received signal strength.

If the wireless resource is re-allocated to users on the side of more users when the users have time constraints in allocation, the probability of providing gradual variations in received signal strength can be raised. This allows the AGC to follow variations in received signal strength more accurately, and degradation in quality of reception can be suppressed. The base station according to the above embodiments allocates communication to the wireless terminal that causes the smallest change in received signal strength from the received signal strength provided by the wireless terminal to which the wireless resource is allocated currently.

Therefore, the base station can receive data sent from the wireless terminals in such a manner that the received signal strength varies gradually. The AGC can follow variations in received signal strength more accurately, and degradation in quality of reception can be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that various changes, substitutions and alterations could be made hereto without departing from the spirit and scope of the invention.

What is claimed is:

1. A base station that performs scheduling of wireless terminals, the base station comprising:
a received signal strength calculation unit that calculates received signal strength of data sent by the wireless terminals; and
a scheduler that allocates communication to a wireless terminal which will cause the smallest change from the received signal strength of a currently allocated wireless terminal.

2. The base station according to claim 1, wherein the received signal strength calculation unit calculates the received signal strength on the basis of request signals sent by the wireless terminals.

3. The base station according to claim 1, further comprising:
a distance measurement unit that measures distances between the base station and the wireless terminals,
wherein the received signal strength calculation unit calculates the received signal strength on the basis of the distances.

4. The base station according to claim 1, wherein the scheduler allocates a wireless resource to the wireless terminals in order of severity of time constraints on allocation permission time for the wireless resource.

5. The base station according to claim 1, wherein the scheduler allocates a wireless resource to wireless terminals on a side of more wireless terminals to be scheduled.

6. The base station according to claim 1, wherein the scheduler allocates the wireless resource to a wireless terminal having severe constraints on allocation permission time for the wireless resource, on a side of more wireless terminals.

7. A wireless terminal that receives scheduling information indicating transmission allocation, the wireless terminal comprises:
receiving from a base station a result of scheduling in which transmission is allocated to a wireless terminal that will cause the smallest change from received signal strength of a currently allocated wireless terminal, on the basis of received signal strength of data transmitted by wireless terminals that include the wireless terminal in question; and
sending data in accordance with the result of scheduling.

8. A scheduling method for scheduling wireless terminals, the scheduling method comprising:
calculating received signal strength of data sent by the wireless terminals; and
allocating communication to a wireless terminal that will cause the smallest change from the received signal strength of a currently allocated wireless terminal.
